(19) United States
(12) Patent Application Publication
(10) Pub. No.: US 2011/0156872 A1
(43) Pub. Date: Jun. 30, 2011

(54) SMART RFID READER/ROUTER

(75) Inventor: Michael Wengrovitz, Concord, MA (US)

(73) Assignee: Alcatel-Lucent USA Inc., Murray Hill, NJ (US)

(21) Appl. No.: 12/650,850

(22) Filed: Dec. 31, 2009

(51) Int. Cl. G06F 13/00; H04Q 5/22

(52) U.S. Cl. 340/10.1; 710/100

(57) ABSTRACT

A smart RFID reader/router is disclosed for connecting RFID readers to a data network. The smart RFID reader/router includes a plurality of connection ports for RFID readers, a plurality of data network ports for connection to a data network, and an internal processor for providing middleware and routing processing functionality. The smart RFID reader/router is particularly useful for moving RFID processing power to the edge of the network.

### FIELD OF THE INVENTION

The present invention relates to a smart RFID reader/router and is particularly concerned with providing intelligent routing services at the network edge to RFID readers.

### BACKGROUND OF THE INVENTION

RFID stands for Radio Frequency IDentification. It typically applies to a technology that uses radio waves to automatically identify people or objects. While there are various ways to identify, the most common is to store a serial number that represents a person or object identity and possibly other information, on a microchip that is attached to an antenna. Collectively the microchip and antenna represent a RFID transponder or an RFID tag. The antenna gives the chip ability to transmit identity information to a RFID reader. Then the RFID reader converts the radio waves into digital information that can then be passed to a computer for usage.

The typical RFID system includes an RFID reader and an RFID transponder located in a card or label. RFD readers wirelessly communicate with the RFID transponders through the use of radio frequency (RF) signals. The readers send out an RF signal that “wakes up” the REID transponder. The transponder then transmits a data signal back to the interrogator via an RE frequency signal.

RFID microchip card technology is based upon two standards: ISO/IEC 14443 Type A and Type B (for proximity cards), and ISO/IEC 15693 (for vicinity cards). Cards that comply with these standards operate at the 13.56 MHz frequency. ISO/IEC 14443 products have a range of up to 10 cm (centimeters), while ISO/IEC 15693 products can operate at a range between 50 and 70 cm.

RFID readers have traditionally been the sensor portion of a larger network, such as with an access security system, or at point-of-sale terminals in retail establishments. Referring to FIG. 1, there may be seen an example of such a centralized system 100. The centralized controller 102 has connections to remotely deployed RFID readers 104, 106, and 108. RFID transponder 110, embedded in a label or security ID card, can be read by one of the RFID readers 104, 106, or 108; and the resulting tagID and readerID information can be received at centralized controller 102. Centralized controller 102 has access to a database 112 which maintains particulars about appropriate responses to take by centralized controller 102 when a tag ID is registered.

More recent developments in RFID readers, such as for example RFID readers by Advanced Card Systems Ltd. (web site: http://www.acs.com.hk/index.php), have made available RFID readers as separately available technology product items which can be interfaced to computers via Universal Standard Bus (USB) ports. This greatly simplifies the development and deployment of RFID applications as a personal computer (PC) can be used to read RFID data and then process the data appropriately for the intended application. For example, the PC can communicate the information over a data network, such as the Internet, and initiate services upon a server in the network's core.

Referring to FIG. 2 there may be seen such a system 200. Personal computer 202 connects via USB cable 214 at socket 216 to RFID reader 205. A wireline connection to a data network, for example the Internet, occurs via cable 219 connected at connector 218 of PC 202. RFID transponder 210 can be read by the RFID reader 205, and the resulting tagID and readerID information can be received at PC 202.

A potential drawback inherent to this approach is the associated overhead of dedicating a PC to an RFID reader in environments where a plurality of RFID readers were to be deployed. Such environments include trade-fairs and trade-shows, shopping concourses, tourist points, and the like.

In terms of standard PCs, each RFID reader's PC is physically inconvenient and awkward to mount, must be powered-on and not rebooted, and is not energy-green especially for systems involving thousands of NFC readers. The RFID reader's PC typically provides minimal data processing and simply forwards the data over IP to a centralized server. This server at the system's core represents a system single point of failure, and in some cases, such as RFID supply chain management or multiple loyalty card presentation, security is inadequate—vendor1 and vendor2 simply do not want their competitive data on the same server in the system's core.

Therefore, it would be desirable to have an apparatus which would provide for connection of RFID readers to a network while overcoming the limitations of using standard personal computers as available in the prior art.

### SUMMARY OF THE INVENTION

An object of the present invention is to provide an improved apparatus for connecting of RFID readers to a data network.

According to an aspect of the invention there is provided an apparatus for interconnecting an RFID reader to a data network, the apparatus including a router; a data port on the router for connecting to the data network; an interface port the router for connected to the RFID reader; a processor, located within the router; and an operating system for controlling the processor so as to provide interconnect functionality between the RFID reader and the data network.

In some embodiments of the invention the data port includes a plurality of wireline ports and in others the data port includes a wireless access port, while in yet others the interface port comprises a Universal Serial Bus port

Advantageously, in some embodiments of the invention the operating system comprises a LINUX operating system.

Also advantageously, in some embodiments of the invention the interconnect functionality includes at least one networking protocol from the group of UDP, TCP, HTTP, HTTPs Rest, and SOAP/XML protocols.

In some embodiments of the invention the interconnect functionality includes provides firewall functionality.

According to another aspect of the invention, the router also contains additional instructions for processing data received from the RFID reader. In some embodiments the additional instructions include using data received from the RFID reader to perform application-correlation against a predetermined set of tag/reader templates.

According to some embodiments, the application correlation is used to select one of plurality of processing schemes, and in others to select one of plurality of routing schemes. According to some of the embodiments, the routing schemes include at least one of the group of UDP, TCP, HTTP, HTTPs Rest, and SOAP/XML protocols.

Advantageously, in other embodiments, the apparatus uses the application-correlation to suitably modify at least one of the source and destination data network addresses of a packet containing the data received from the RFID reader. In some other embodiments, the apparatus uses the application-correlation to select an authentication protocol for use before transmitting packets containing the data received from the RFID reader, or uses the application-correlation to select an encryption protocol for use before transmitting packets containing the data received from the RFID reader.

In other embodiments, the additional instructions include using data received from the RFID reader to select one of a plurality of data network ports on the router, and in some cases one of the plurality of data network ports includes the wireless access port.

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which:

FIG. 1 illustrates an example of RFID readers connected to a centralized controller in accordance with the known art;

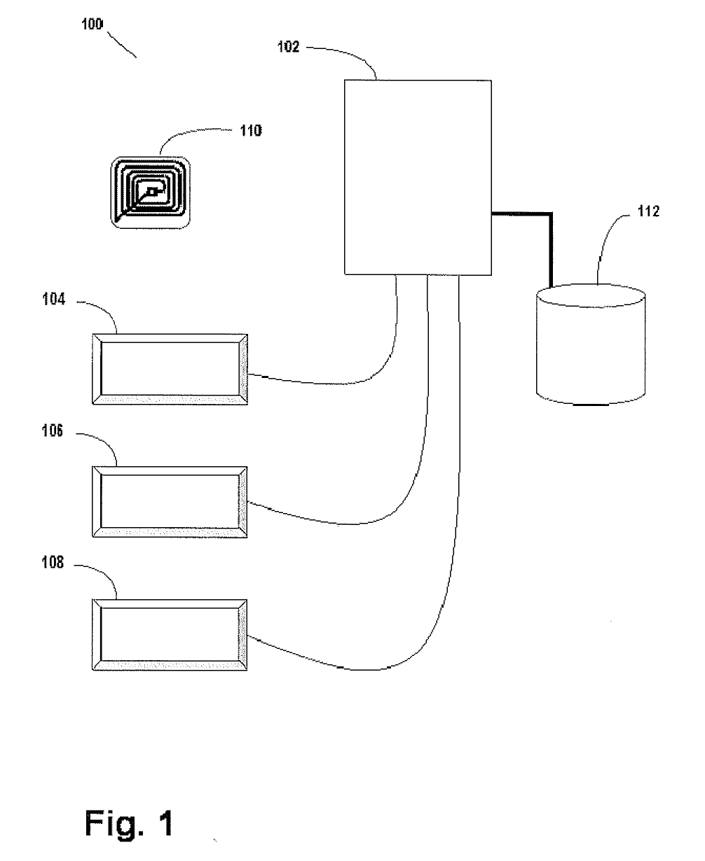

FIG. 2 illustrates an example of an RFID reader connected to a network via a personal computer in accordance with the known art; and

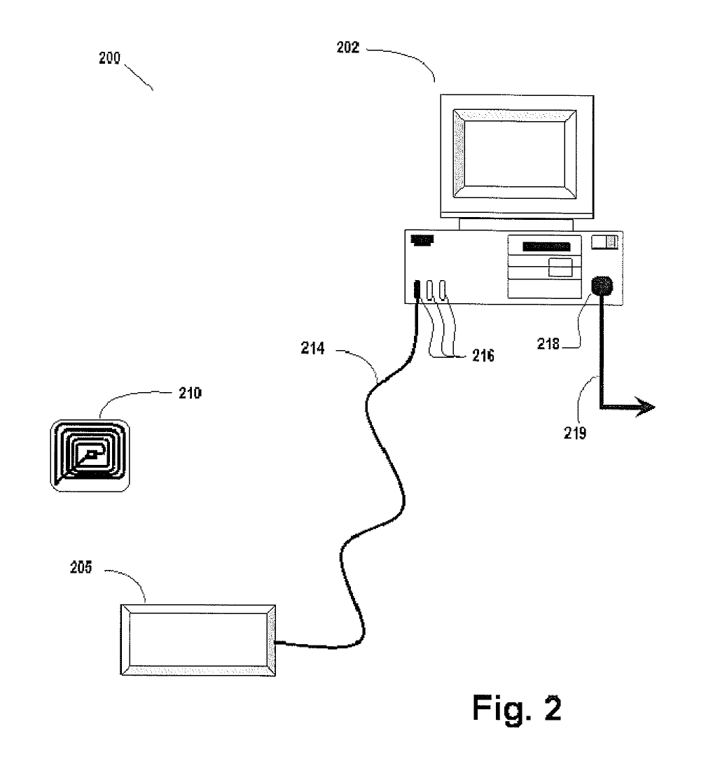

FIG. 3 illustrates an example of an RFID reader connected to reader/router in accordance with an embodiment of the invention.

### DETAILED DESCRIPTION

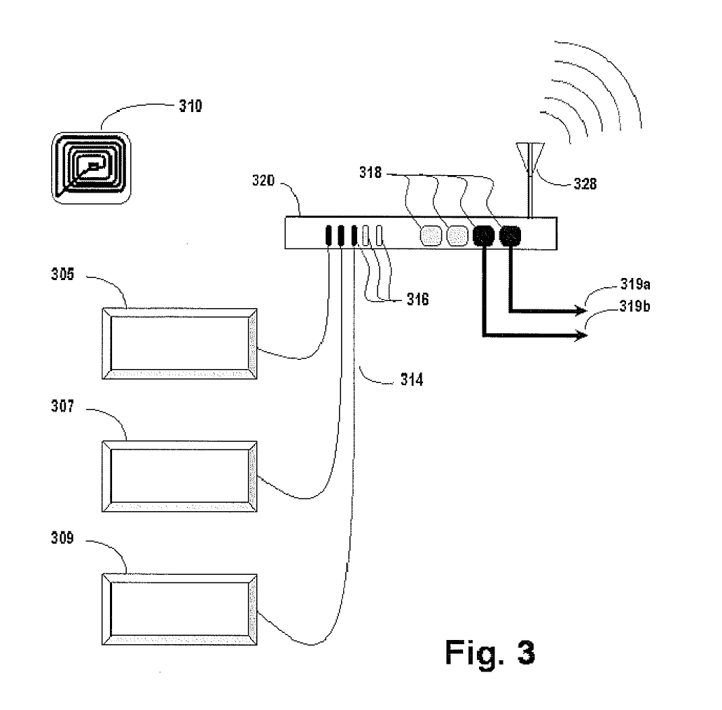

Referring to FIG. 3, there may be seen a block diagram of an embodiment of the invention. Smart RFID Reader/Router (SRRR) 320 connects via USB cables 314 at USB ports 316 to a plurality of RFID readers 305, 307, and 309. SRRR 320 also connects to a data network, such as the Internet, via wireline cables 319a and 319b at connectors 318. SRRR 320 further connects via a wireless protocol, indicated by antenna 328, to a wireless access point (not shown), for example via IEEE 802.11 protocol. RFID transponder 310, embedded in a label or security ID card or other object, can be read by one of the RFID readers 305, 307, or 309; and the resulting tagID and readerID information can be received at SRRR 320 for further processing.

According to one embodiment, SRRR 320 incorporates an embedded Linux operating system to provide RFID reader interfacing, a Firewall, and Network Address Translation (NAT) support.

As may be seen, the SRRR 320 contains multiple USB ports, thereby allowing multiple RFID readers to be attached.

It is contemplated that a typical SRRR 320 will contain powerful real-time microprocessors chip sets, such as Broadcom ARM CPU devices, capable of implementing complex packet processing software in real-time such as IPtables or the OpenSer SIP VoIP registrar/proxy. The embedded Linux operating system makes it possible to create, compile, install and upload custom firmware routines, thereby allowing smart processing/routing applied to RFID reader data. Such uploads may be accomplished prior to commissioning the SRRR, or after commissioning via network connections.

Examples of smart processing/routing that are contemplated in the SRRR include:

1) using the tagID and readerID information received from the RFID reader to perform application-correlation against tag/reader templates, so as to select one of many possible processing and IP routing schemes,

2) use the tagID and readerID data to suitably modify the source and/or destination IP addresses of the packet containing the raw or processed tagID and readerID data for suitable routing to multiple external services;

3) use the tagID and readerID data to select the type of IP transmission, ie UDP, TCP, HTTP, HTTPs Rest, SOAP/XML, etc. in order to comply with multiple/different service provider interfaces;

4) use the tagID and readerID data to select the appropriate IP egress port on the SRRR;

5) use the tagID and readerID data to select the VLAN and/or set TOS bits for the IP packet for network priority and VLAN management;

6) use the tagID and readerID to perform suitable encryption/authentication (VPN encryption, HTTPS with challenge-response, and the like) before sending along each packet containing raw or processing tagID and readerID data to one of many possible service providers having differing security schemes;

7) use the tagID and readerID to communicate with an external service potentially containing a database in order to perform suitable packet processing and construction;

8) use the tagID and readerID to perform NAT processing and firewall SPI processing so as to isolate an internal network from an external network and to protect the sensors from hacking, denial-of-service attacks, and the like;

9) use the tagID and readerID data to perform port mapping so that RFID packets exit with different source and destination ports;

10) use the tagID and readerID to differentially route some/all packets over the wireless data connection 328 and other packets over wireline network connection at 318. For example, the SRRR may be used in an access-point client mode with WEP or WPA in order to attach to existing WiFi access point infrastructure for wireless connectivity.

The operating system present in the SRRR is also contemplated to support middleware. Middleware comprises software functions such as data collection, filtering, aggregation, and reporting of tag reads from RFID readers to higher-level applications. The SRRR satisfies the generally desirable requirement that filtering and processing of information (e.g., of RFID reads) should occur as close to the network edge as possible, for bandwidth optimization, manageability, and security.

It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.” Numerous modifications, variations and adaptations may be made to the embodiment of the invention described above without departing from the scope of the invention, which is defined in the claims.

What is claimed is:

1. An apparatus for interconnecting an RFID reader to a data network comprising:
a router;
a data port on said router for connecting to said data network;
an interface port said router for connected to said RFID reader;
a processor, located within said router; and
an operating system for controlling said processor so as to provide interconnect functionality between said RFID reader and said data network.

2. An apparatus as claimed in claim 1,
wherein said data port comprises a plurality of wireline ports.

3. An apparatus as claimed in claim 1,
wherein said data port comprises a wireless access port.

4. An apparatus as claimed in claim 1,
wherein said interface port comprises a Universal Serial Bus port.

5. An apparatus as claimed in claim 1,
wherein said operating system comprises a LINUX operating system.

6. An apparatus as claimed in claim 1,
wherein said interconnect functionality comprises at least one networking protocol from the group of UDP, TCP, HTTP, HTTPs Rest, and SOAP/XML protocols.

7. An apparatus as claimed in claim 6,
wherein said interconnect functionality comprises provides firewall functionality.

8. An apparatus as claimed in claim 1, further comprising
additional instructions for processing data received from said RFID reader.

9. An apparatus as claimed in claim 8,
wherein said additional instructions include using data received from said RFID reader to perform application-correlation against a predetermined set of tag/reader templates.

10. An apparatus as claimed in claim 9,
using said application-correlation to select one of plurality of processing schemes.

11. An apparatus as claimed in claim 9,
using said application-correlation to select one of plurality of routing schemes.

12. An apparatus as claimed in claim 11,
wherein said routing schemes comprises at least one of the group of UDP, TCP, HTTP, HTTPs Rest, and SOAP/XML protocols.

13. An apparatus as claimed in claim 9,
using said application-correlation to suitably modify at least one of the source and destination data network addresses of a packet containing the data received from said RFID reader.

14. An apparatus as claimed in claim 9,
using said application-correlation to select an authentication protocol for use before transmitting packets containing the data received from said RFID reader.

15. An apparatus as claimed in claim 9,
using said application-correlation to select an encryption protocol for use before transmitting packets containing the data received from said RFID reader.

16. An apparatus as claimed in claim 8,
wherein said additional instructions include using data received from said RFID reader to select one of a plurality of data network ports on said router.

17. An apparatus as claimed in claim 16,
wherein said one of a plurality of data network ports comprises the wireless access port.
